(19) United States
(12) Patent Application Publication
(10) Pub. No.: US 2014/0095217 A1
(43) Pub. Date: Apr. 3, 2014

(54) Online Booking System

(71) Applicants: Mark Armstrong, Plano, TX (US); Stefano Grossi, Atlanta, GA (US); Ken Sauter, Garland, TX (US)

(72) Inventors: Mark Armstrong, Plano, TX (US); Stefano Grossi, Atlanta, GA (US); Ken Sauter, Garland, TX (US)

(21) Appl. No.: 13/631,233

(22) Filed: Sep. 28, 2012

(51) Int. Cl. G06Q 10/02

(52) U.S. Cl. 705/5

(57) ABSTRACT

An online booking system includes a computer connected to a wide-area network, the computer including a processor and a memory configured to store programming and data. An act database includes entertainment records associated with a plurality of entertainers. Programming causes the processor to receive a performance request from a talent buyer over the network, the performance request including performance request data regarding an open performance date desired to be booked. The system determines if the performance request data matches a respective entertainment record in the act database and, if so, notifies a respective entertainer associated with the selected act to contact the buyer. If the act is booked, the processor updates the act and talent buyer itinerary databases. Matching a performance request with entertainment records may include determining if an entertainer is available within a predetermined number of days of the performance date and within a predetermined distance.

### BACKGROUND OF THE INVENTION

This invention relates generally to scheduling systems and, more particularly, to an online booking system that enables entertainers, talent buyers, and agents to identify and book live entertainment “gigs.” The online booking system enables talent buyers to fill their open dates quickly and easily while enabling live entertainers to maximize their bookings.

Individuals and non-profit institutions spend billions of dollars on live entertainment. The U.S. performing arts community includes nearly 8,840 organizations with a total of over 127,000 paid workers. These organizations generate over $13 billion in annual revenues. The commercial casino industry supported approximately $125 billion in spending and nearly 820,000 jobs in the U.S. economy in 2010. Further, the North American cruise industry generated nearly 330,000 jobs that contributed over $15 billion to the US economy. A significant amount of all cruise ship consumer spending goes to live entertainment. Still further, spending on live entertainment by nightclubs and lounges, colleges and universities, and fairs and festivals confirms that live entertainment is a significant portion of the U.S. economy. Booking agents are often utilized by both entertainers and “talent buyers” (e.g. the administrator of a venue seeking an entertainer to fill a performance opening, i.e. a “gig”).

Many of the venues for live entertainment described above seek to use local talent. Whether seeking local talent or not, talent buyers seeking to book entertainers face a daunting task of obtaining contact information for each potential act and then of contacting each potential act regarding availability, pricing, content of act, etc. For instance, a talent buyer associated with a university may be seeking a band to spice up a year-end event on campus. This talent buyer must determine what bands may be located within a generally accessible distance and may be available on the needed date. All potential bands must be personally contacted to determine this information before a booking request may be extended.

On the other hand, there are many live entertainers who desire to be booked by talent buyers but are without knowledge of what “gigs” are available in their area, available dates, payment terms, etc. Each entertainer faces the same daunting task of spending an undesirable amount of time determining the aforementioned information and then booking gigs. All of this takes the entertainer away from what he loves to do most of all—performing. These entertainers are “second tier” entertainers who must work diligently to book their itineraries unlike “first tier” entertainers who are sought after for very large concerts and are well known in the mainstream media.

In summary, talent buyers are spending undesirable amounts of time filling day to day slots with appropriate and available entertainment acts while second tier entertainers are spending too much of their time, energy, and resources just looking for gigs.

Various online booking systems are known in the art for matching entertainers with talent buyers. Although assumably effective for their intended purposes of providing repositories of information, the existing systems do not specifically emphasize the needs of music and variety entertainers/buyers and do not provide logistics for connecting available traveling entertainers with nearby venues.

Therefore, there is a desire to provide an online booking system that enables talent buyers to have an efficient means for booking live entertainment gigs without tedious research and contacting of entertainers. Further, there is a desire to provide an online booking system that enables entertainers to efficiently fill their itinerary calendars without making multitudes of phone calls and record keeping. In addition, there is a desire to provide an online booking system that connects talent buyers looking for local talent with traveling entertainers who may be nearby at the needed date or time.

### SUMMARY OF THE INVENTION

An online booking system according to the present invention includes a computer connected to a wide-area network, the computer including a processor and a memory configured to store programming and data. An act database includes entertainer records associated with a plurality of entertainers. Programming causes the processor to receive a performance request from a talent buyer over the network, the performance request including performance request data regarding an open performance date desired to be booked. The system determines if the performance request data matches a respective entertainment record in the act database and, if so, notifies a respective entertainer associated with the selected act to contact the buyer. If the act is booked, the processor updates act and talent buyer itinerary databases. Matching a performance request with entertainment records may include determining if an entertainer is available within a predetermined number of days of the performance date and within a predetermined distance. A reverse transaction is also provided; namely, an entertainer may search for all gigs that are available with specified dates and times and, once located by the system, book a selected gig.

Therefore, a general object of this invention is to provide an online booking system that enables talent buyers an efficient means for booking live entertainment gigs.

Another object of this invention is to provide an online booking system, as aforesaid, that coordinates and organizers the needs of entertainers and talent buyers in a searchable database.

Still another object of this invention is to provide an online booking system, as aforesaid, that enables entertainers to efficiently fill their itinerary calendars without making multitudes of phone calls and record keeping.

Yet another object of this invention is to provide an online booking system, as aforesaid, that includes an easy-to-navigate internet user interface.

A further object of this invention is to provide an online booking system, as aforesaid, in which the administrator of the system receives a fee or commission for every gig booked through the system.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a flowchart for an online booking system illustrating a process for establishing databases of acts, act itineraries, talent buyers, and talent buyer itineraries;

FIG. 2 is a flowchart for the online booking system as in FIG. 1 illustrating a process of a talent buyer searching for an act to book;

FIG. 3 is a flowchart for the online booking system as in FIG. 1 illustrating a process of an entertainer searching a performance opportunity to book;

FIG. 4 is a block diagram of the electronic components of the online booking system; and

FIG. 5 is a block diagram illustrating the data structure of a memory.

### DESCRIPTION OF THE PREFERRED EMBODIMENT

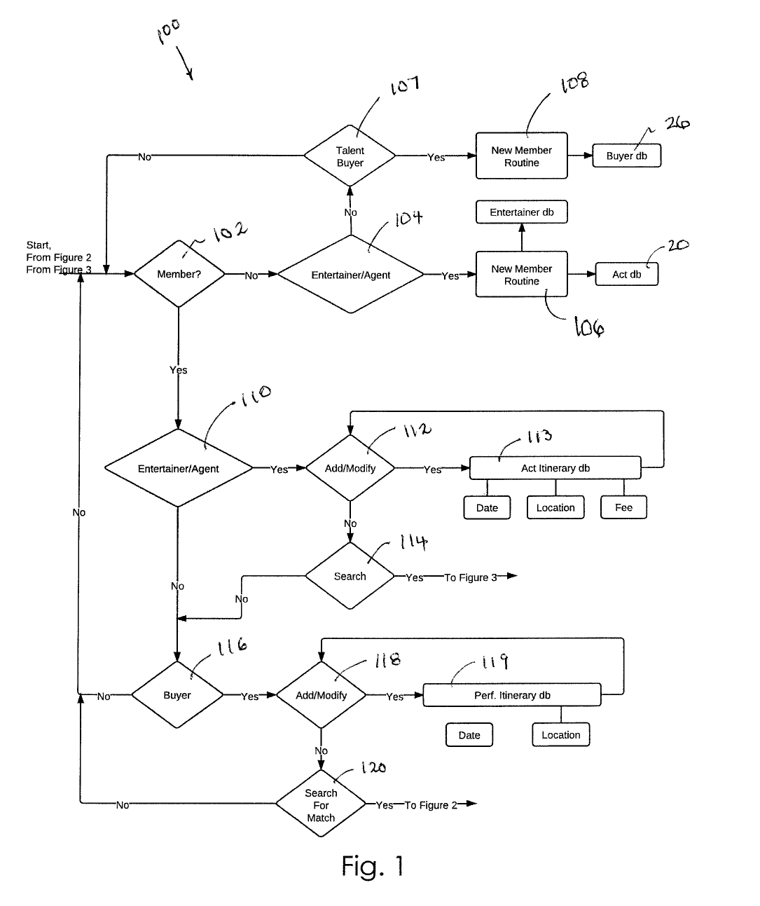

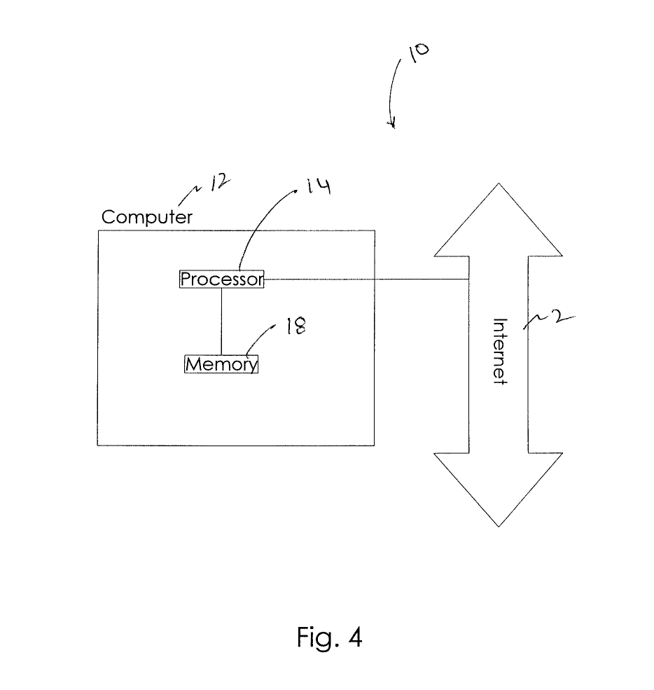

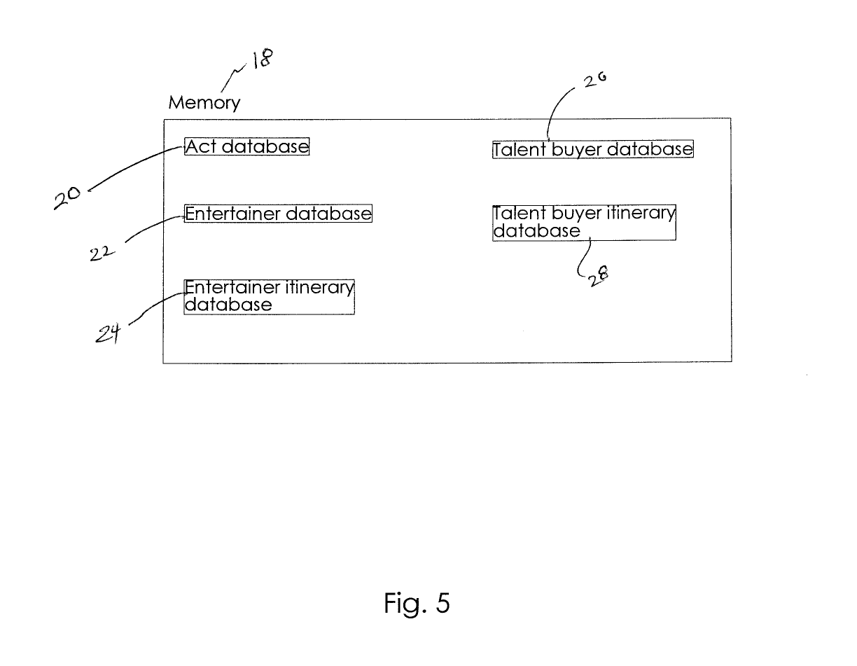

An online booking system will now be described in detail with reference to FIGS. 1 to 5 of the accompanying drawings. The online booking system 10 includes at least one computer 12, such as a network server, operably connected to the internet and accessible by remote computers in a traditional manner. Specifically, the online booking system 10 is designed to be used by entertainers and by talent buyers to identify and communicate efficiently with one another so as to book entertainment performances referred to herein as “gigs.”

The computer 12 may include a memory 18 configured to store a plurality of programming instructions and a processor 14 configured to selectively execute the program instructions in a manner that operates the system 10 as will be described below. The memory 18 may also be structured so as to store a plurality of data structures such as one or more databases and data that may be stored and manipulated by operation of the programming instructions.

Data structures stored in the memory 18 may include, but not be limited to the databases described below. The system 10 may include an act database 20 that may include information about a plurality of entertainers and their associated acts. More particularly, the act database 20 may include a plurality of entertainer records containing data such as contact information for each respective entertainer, information concerning the type or category of the entertainer's act, the amount of time the entertainer estimates for setup and tear down of the act, the performer's language, the lowest fee the entertainer would ever accept to perform, the highest fee the entertainer would ever charge to perform, and other information relevant to an entertainer's act or that a buyer of the act would find helpful. For instance, the “type” of act may include that the entertainer is a magician, an impersonator, a hypnotist, a singer, a dancer, a band, etc. The act database 20 may be searchable by talent buyers seeking to book entertainers for their venues, as will be described in detail later.

The system 10 may also include an entertainer database 22 stored in memory 18 that includes details about each act, such as personal information, contact information, and the like. Preferably, the contact information includes at least one e-mail address so that a respective entertainer may be contacted quickly and electronically, understanding that many e-mails are now routed directly to one's mobile telephone, laptop computer, or tablet. Being able to contact an entertainer quickly and effortlessly is important to making a booking transaction as will be described more fully later. In some embodiments, the act database 20 and entertainer database 22 may be included a single database.

The system 10 may also include an entertainer itinerary database 24 stored in memory 18. The entertainer itinerary database 24 may include data concerning each date, location, time, fee, and other information relevant to a booked date. The entertainer itinerary database 24 may also include data indicative of which days, times, and locations that an entertainer is available and desires to be hired by a talent provider, as will be discussed below in greater detail.

The system 10 may also include a talent buyer database 26 stored in memory 18. The talent buyer database 26 may include a plurality of records, each record including a buyer's contact information, venue location, language preference, and the like. The talent buyer database 26 may be searched by entertainers seeking to book gigs with talent buyers as will be described in further detail below.

The system 10 may include a talent buyer itinerary database 28 stored in memory 18. The talent buyer itinerary database 28 may include records having data indicative of what dates and times have already been booked with an entertainment act and what dates and times are still available/desired to be booked. The data in this database may also include venue location, type of act desired, payment terms, and the like. The talent buyer itinerary database 28 may be searched by entertainers seeking to match their available dates with available dates of respective talent buyers.

The databases may be filled with respective data by entertainers and talent buyers who use the system 10. Preferably, both entertainers and talent buyers must sign up as members before authorization is given to utilize the system although other access options may also work. Once a member, an entertainer may login—such as with a username and password—and choose to upload information to the entertainer database, such as personal and contact information. Similarly, an authorized entertainer may upload information concerning the type or types of acts he or she is associated with, profile pictures and videos of the act, lowest fee and highest fee possible to book the act, and other pertinent information. Further, a member entertainer may enter availability data which may be stored according to programming instructions in the entertainer itinerary database 24. Available dates for which an entertainer wishes to book gigs may be entered one date and time at a time or by uploading an entire calendar of dates and times. It is important to segregate each day into multiple available portions in that the entertainer may seek to book multiple gigs in a single day.

Similarly, a talent buyer who becomes a member of the system 10 may login and enter contact information which is then stored in the talent buyer database 26. A member talent buyer may also enter itinerary data indicative of what dates are or are not available and desired to be filled by entertainment acts. Itinerary information may be entered one date and time at a time or by uploading an entire calendar of event openings. This data may include date, time, desired act, venue location data, payment terms, and the like.

Operation of the system 10 according to an exemplary process is illustrated in the flowcharts of FIGS. 1 through 3 and will be described below. It is understood that the steps of the process are carried out by the processor 14 executing programming stored in memory 18. A setup process 100 includes programming for receiving entertainer and talent buyer data into respective databases as described above.

As shown in FIG. 1, the process 100 begins at step 102 where the processor 14 determines if a user attempting to login to the computer 12 is a member of the system 10. If the attempted login is determined to be from a member, then the process 100 proceeds to step 110; otherwise, the process 100 proceeds to step 104. At step 104, the processor 14 determines if the user is an entertainer or agent and, if so, the process 100 proceeds to step 106; otherwise the process 100 proceeds to step 107. At step 106, the processor 140 executes a new member routine for entertainers. The new member routine may include receiving data that is stored in the act database 26 and the entertainer database 22, respectively, as described above. These databases are searchable according to the process 100 as will be described later.

At step 107, the processor 14 determines if the user is a talent buyer and, if so, the process 100 proceeds to step 108; otherwise, the process 100 returns to step 102. At step 108, the processor 14 executes a new member routine for new talent buyers. This routine may include receiving the data that is stored in the talent buyer database 26 described above.

At step 110, the processor 14 determines if the member who is logged in is an entertainer or agent and, if so, the process 100 proceeds to step 112; otherwise the process 100 proceeds to step 116. At step 112, the processor 12 determines if the user desires to add or modify records in the act itinerary database 24 and, if so, the process 100 proceeds to step 113 where the act itinerary database 24 is edited or amended. Otherwise, the process 100 proceeds to step 114. It is understood that the user may upload his itinerary in part or in total so that the database will reflect what dates the entertainer has already booked and what dates he is available.

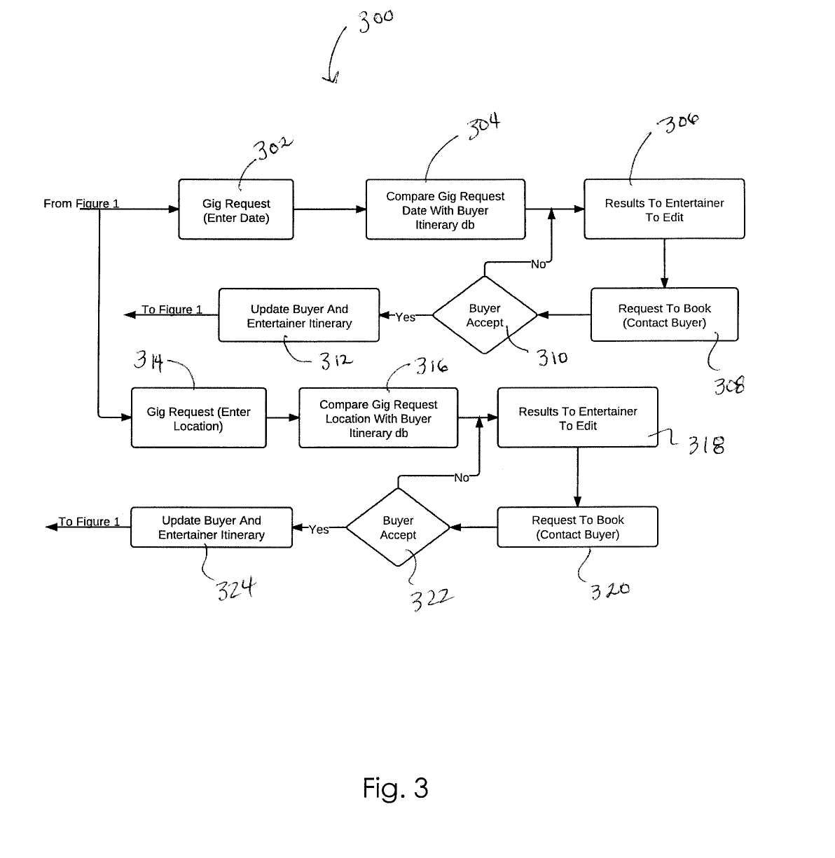

At step 114, the processor 14 determines if the user (i.e. the member entertainer) desires to search the talent buyer itinerary database 28 and, if so, the process proceeds to the process 300 shown in FIG. 3, which may be referred to as the Entertainer Search Routine in that an entertainer is able to search for an available gig to book. The test of step 114 indicates that the user desires to match his available dates with available dates in the talent buyer itinerary database as will be described below. If a search is not desired at step 114, the process 100 returns to step 102.

At step 116, the processor 14 determines if the logged in member is a talent buyer and, if so, the process 100 proceeds to step 118; otherwise, the process 100 returns to step 102. At step 118, the processor 14 determines if the talent buyer desires to modify or add to the talent buyer itinerary database 28 and, if so, the process 100 proceeds to step 119; otherwise the process 100 proceeds to step 120. At step 119, the processor 114 receives the talent buyer's itinerary details concerning a date or dates that are desired to be matched to an entertainer's act. Data regarding a date and/or location may be received.

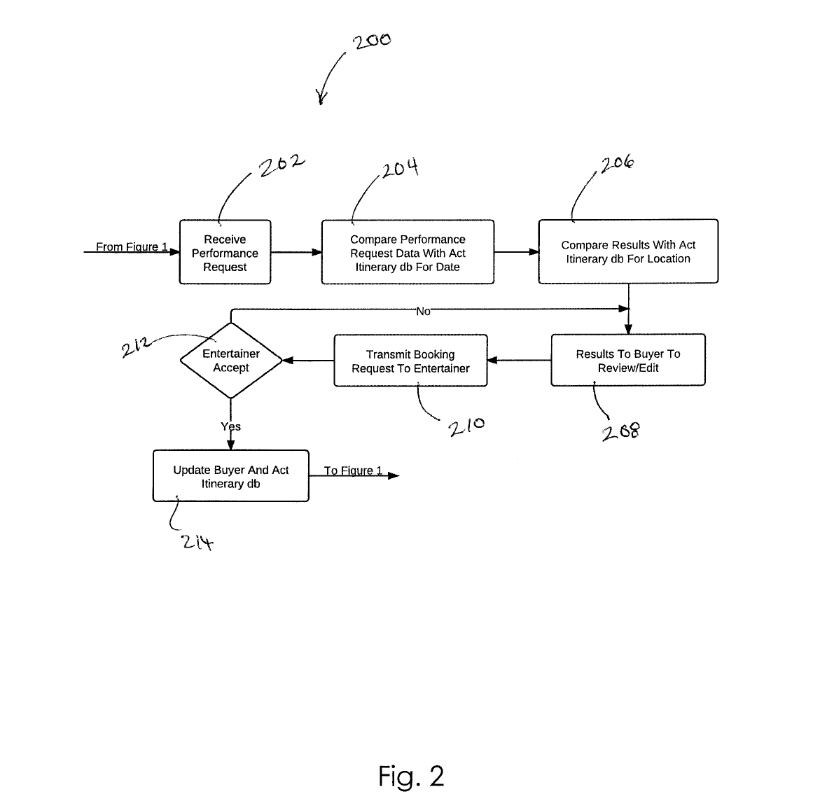

At step 120, the processor 14 determines if the talent buyer desires to search the entertainer databases for an act that may match a desired “open” date needing to be filled. If so, then the process 100 proceeds to process 200 illustrated in FIG. 2 and which may be referred to as the Talent Buyer Search Routine as it refers to a talent buyer searching for an appropriate act to book. If a search is not desired, then the process 100 returns to step 102.

At step 202 (FIG. 2), the processor 14 receives a performance request from a requesting talent buyer. In other words, the talent buyer has indicated a desire to find an act to book on a particular date and the process 200 performs a routine to find a suitable match. After receiving a request to find an act meeting certain criteria such as date, time, location, and type, the process 200 proceeds to step 204. At step 204, the processor 14 may execute programming that compares the performance request data with the act itinerary database 24 for an available act having a matching date. Then, the process 200 proceeds to step 206 at which the processor 14 may determine which of the previous search results also match the performance request location. More particularly, this may require the processor 14 to search the act itinerary database 24 to determine acts within a predetermined distance of the location, such as 400 miles of the performance request location. It is understood that the search to find a suitable act for the desired performance request may involve multiple searches of both the act database and the act itinerary database 24 so as to successively filter the results to meet the performance request parameters. For instance, one search may be to match all acts having the same performance type, another to match a specified performance dates, and yet another to determine a specified performance location.

It is understood that acts may be determined by the processor to match a performance request date and location if the act is within a predetermined distance of the performance request location that is also within, for example, three days prior to or after the request date location. This test considers a hypothetical situation where an entertainer is booked to perform in a location on a specific day and is booked to perform nearby three days later. The programming of the present system 10 is configured to consider this act as being available to a performance request having a date and location falling between this entertainer's two bookings. This enables the entertainer to book another gig during the brief downtime between already booked acts. In another example, the programming is configured to identify an entertainer who is booked in a geographic area and who has or will be completing a gig just a day or two before the talent buyer's requested date and location such that the entertainer may choose to stay in that area for one or two more days in order to work the additional gig. It is understood that this efficiency is only possible because the processor 14 searches the act itinerary database 24 that shows the present location of the entertainer/act and not just the home location of the entertainer/act identified in the act database 20.

After filtering search results as described above, the process 200 proceeds to step 208 at which the search results meeting the performance request parameters are communicated to the requesting talent buyer to consider and edit. The requesting talent buyer may save them for later review, delete one or more requests that are not pertinent or desired, or select a search result desired to be booked. The process 200 then proceeds to step 210 at which the “gig request” initiated by the selected act, hereafter referred to as a “booking request,” is communicated to a respective entertainer associated with the selected act. Preferably, the booking request is transmitted by e-mail to the respective entertainer although communication by text message, telephone message, or traditional mail would also work.

The process 200 then proceeds to step 212. At step 212, the processor 14 determines if the entertainer associated with the booking request has accepted the booking request and, if so, the process 200 proceeds to step 214; otherwise, the process 200 returns to step 208 where the requesting talent buyer may again consider the search results and potentially select a different act. At step 214, the processor 14 updates the act itinerary database 24 and the talent buyer database 28. Then, the process 200 returns to step 102 and the process 100 begins again. It is understood that at a predetermined time before the booked event, the talent buyer will compensate the entertainer and the booking system will receive a predetermined commission on the transaction.

The process 300 is illustrated in FIG. 3. An entertainer desiring to search for a gig opportunity may be presented with a menu or other means for choosing whether to search to find a gig on a particular date (starting at step 302) or at a particular location (starting at step 324). It is understood that both an entertainer and an agent working for an entertainer may utilize process 300 to book a gig for an entertainer. Particular differences in how an agent may utilize process 300 and the system in general will be described later.

At step 302, a requesting entertainer may enter a “gig request” that specifies a date upon which to search for a performance opportunity. In general, a gig request may include gig request data that includes a gig date, a gig location, and a gig type. The process 300 then proceeds to step 304 at which the processor 14 makes a comparison of the talent buyer itinerary database records to the gig request. Specifically, the processor 14 compares the date fields of each to determine a set of un-booked performances that match the criteria of the gig request, namely, a performance opportunity of an appropriate type and on the specified date. The process 300 proceeds to step 306 where the match results are communicated to the requesting entertainer to review and edit. The process 300 proceeds to step 308 at which a booking request is communicated to a respective talent buyer associated with the selected performance opportunity (“gig”). The process 300 then proceeds to step 310 at which the processor determines if the associated talent buyer has accepted the booking request and, if so, the process 300 proceeds to step 312; otherwise, the process 300 returns to step 306 at which the requesting entertainer may review and select another performance opportunity from the search result. At step 312, the processor 14 updates both the talent buyer and entertainer itinerary databases and the process 300 returns control to step 102. As indicated earlier, the system 10 may require the respective talent buyer to compensate the entertainer prior to the date of the gig along with a commission to the system.

At step 314, a requesting entertainer may enter a “gig request” that specifies a geographic location upon which to search for a performance opportunity. The process 300 then proceeds to step 316 at which the processor 14 makes a comparison of the talent buyer itinerary database records to the gig request. Specifically, the processor 14 compares the location fields of each to determine a set of un-booked performances that match the criteria of the gig request, namely, a performance opportunity of an appropriate type and at the specified location. The process 300 proceeds to step 318 where the match results are communicated to the requesting entertainer to review and edit. The process 300 proceeds to step 320 at which a booking request is communicated to a respective talent buyer associated with the selected performance opportunity (“gig”). The process 300 then proceeds to step 322 at which the processor determines if the associated talent buyer has accepted the booking request and, if so, the process 300 proceeds to step 324; otherwise, the process 300 returns to step 318 at which the requesting entertainer may review and select another performance opportunity from the search result. At step 324, the processor 14 updates both the talent buyer and entertainer itinerary databases and the process 300 returns control to step 102. It is understood that in one embodiment, the date and location searches of process 300 may be combined. In other words, a gig request may include both a date and a location request such that search results will be immediately filtered according to both search parameters.

In addition, a requesting talent buyer or a requesting entertainer may negotiate the terms of a booking request. First, each act record in the act database 20 may include a low fee below which the entertainer will refuse to perform and a high fee representing the highest price the entertainer will charge. These data points may be used to eliminate acts that may otherwise meet date and location requests in a search by a talent buyer if the talent buyer has specified the payment terms of the performance opportunity seeking to be booked. Second, an entertainer and talent buyer may negotiate payment terms during the step of communicating and agreeing on a booking request.

As indicated briefly above, an entertainer's itinerary may specify not only dates of availability, but also specific times of day. For example, an entertainer may specify that his act is available in the morning, afternoon, and evening. The processor 14, therefore, may determine that an entertainer who is already booked for a gig in a location during the morning may still be available for a gig in the evening in the same geographic location or within a predetermined distance thereof. This functionality enables an entertainer to maximize a full schedule to whatever extent he desires and also enables talent buyers to secure traveling entertainers who may have a little more availability than may otherwise appear when viewing available “dates” only. This function may be further refined by each record in the act database including minimum “buffer” times indicative of the amount of time an entertainer needs to set up and tear down his act. In other words, the buffer times may be considered by the processor 14 when determining which acts are available to meet a requesting talent buyer's request. Similarly, the processor 14 may also consider the distance from an entertainer's previous gig and the next (or the “available” gig) when determining if an act is available and should be put into a search result.

The online booking system 10 may also have an automatic schedule filling procedure. More particularly, if one or more entertainers has entered his itinerary into the act itinerary database 24 and on or more talent buyers has entered his itinerary into the talent buyer itinerary 28, the processor 14 under program control may match available acts with available gig dates and locations using at least the logic discussed above. Accordingly, the modified/matched itineraries may then be communicated to respective entertainers and talent buyers. The booking system 10 may also provide an entertainer with complementary data such as hotel, travel directions/times, and the like.

With particular respect to an agent booking a gig or gigs for an entertainer, process 300 illustrates the general means for searching for gigs by location or date. As is known in the industry presently, a single agent may represent multiple entertainers. It will be understood by talent buyers in the present system that communications regarding making an booking offer or request may be to an appropriate agent representing the desired entertainer or act. The agent representing an agent and respective contact information may be included in the entertainer records of the act or entertainer databases.

The online booking system 10 may also include programming instructions that accounts for an entertainer's agent automatically receiving a commission for his services from act's/entertainer's fee. The agent commission may be from 10% to 25% of the entertainer's fee although other amounts may be agreed upon. The end result is that the entertainer pays a 5% fee as an administrative fee to the booking system plus the 10%-25% fee for the agent. In return, the act/entertainer is free not to worry about finding gigs and just spends his time performing, which is what an entertainer loves to do! This is a big benefit for the act/entertainer and is made simple by the present invention.

Accordingly, the online booking system 10 according to the present invention enables entertainers, talent buyers, and agents to identify and book live entertainment “gigs.” The online booking system enables talent buyers to fill their open dates quickly and easily while live entertainers maximize their bookings.

It is contemplated that the online booking system 10 may be adapted to non-entertainment contexts, such as scheduling sales/lead appointments, business scheduling, convention planning, and the like.

It is understood that while certain forms of this invention have been illustrated and described, it is not limited thereto except insofar as such limitations are included in the following claims and allowable functional equivalents thereof.

What is claimed is:

1. An online booking system, comprising:
a computer electrically connected to a computer network, said computer having a memory configured to store programming and data structures;
a processor electrically connected to said computer and to said memory configured to execute said programming;
an act database stored in said memory that includes entertainment records associated with a plurality of entertainers;
programming in said memory that, when executed by said processor, causes said processor to:
receive a performance request from a talent buyer over said computer network, said performance request including performance request data;
determine if said performance request data matches a respective entertainment record in said act database by comparing said performance request data with said entertainment records in said act database;
notify a respective entertainer associated with said matched entertainment record to contact said talent buyer if said performance request data is determined to match said entertainment record associated with said respective entertainer.

2. The online booking system as in claim 1, wherein said performance request data includes a performance date, a performance location, and a performance type.

3. The online booking system as in claim 2, further comprising an act itinerary database having gig date data and gig location data associated with respective entertainment records of said act database such that a respective entertainer's schedule is selectively stored and determined.

4. The online booking system as in claim 3, further comprising programming in said memory that when executed by said processor causes said processor to:
determine if said performance request has been received and, if so, determine from said act database and said act itinerary database a set of available acts that are available on said performance request date and within a predetermined distance of said performance request location; and
communicate said set of available acts to said talent buyer to review.

5. The online booking system as in claim 4, further comprising programming in said memory that when executed by said processor causes said processor to:
receive a booking request from said talent buyer indicative of an offer to book a respective act selected from said set of available acts;
communicate said booking request to a respective entertainer associated with said selected act; and
determine if said booking request is accepted by said respective entertainer and, if so, update said act itinerary database to reflect acceptance of said booking request.

6. The online booking system as in claim 5, further comprising:
a talent buyer itinerary database stored in said memory that includes performance itinerary records associated with a plurality of talent buyers, said performance itinerary record including an open date, an open location, and an open type, such that said itinerary database is indicative of open performances of respective talent buyers desiring to locate and book respective acts; and
programming in said memory that when executed by said processor causes said processor to update said talent buyer itinerary database to reflect acceptance of said booking request.

7. The online booking system as in claim 4, further comprising programming in said memory that when executed by said processor causes said processor to
determine a subset of said set of available acts that match said performance request performance type;
communicate said subset of available acts set to said talent buyer to review;
receive a booking request from said talent buyer indicative of an offer to book a respective act selected from said subset of available acts;
communicate said booking request to a respective entertainer associated with said selected act; and
determine if said booking request is accepted by said respective entertainer and, if so, update said act itinerary database to reflect acceptance of said booking request.

8. The online booking system as in claim 1, further comprising:
a talent buyer itinerary database stored in said memory that includes performance itinerary records associated with a plurality of talent buyers, said performance itinerary record including an open date, an open location, and an open type, such said itinerary database is indicative of open performances of respective talent buyers desiring to locate and book respective acts;
programming in said memory that when executed by said processor causes said processor to:
receive a gig request from a requesting entertainer over said computer network, said gig request including gig request data;
determine if said gig request data matches a respective performance itinerary record in said talent buyer itinerary database by comparing said gig request data with said performance itinerary records in said talent buyer itinerary database;
notify a respective talent buyer associated with said matched performance itinerary record to contact said requesting entertainer if said gig request data is determined to match said performance record associated with said respective talent buyer.

9. The online booking system as in claim 8, wherein said gig request data includes a gig date, a gig location, and a gig type.

10. The online booking system as in claim 9, further comprising programming in said memory that when executed by said processor causes said processor to:
determine from said talent buyer itinerary database a set of available performance records having a respective performance type and open date matching said gig type and said gig request date, respectively; and
communicate said set of available performance records set to said requesting entertainer to review.

11. The online booking system as in claim 10, further comprising programming in said memory that when executed by said processor causes said processor to:
receive a booking request from said requesting entertainer indicative of an offer to book a respective open date selected from said set of available performance records;
communicate said booking request to a respective talent buyer associated with said respective open date; and
determine if said booking request is accepted by said respective talent buyer and, if so, update said talent buyer itinerary database to reflect acceptance of said booking offer.

12. The online booking system as in claim 9, further comprising programming in said memory that when executed by said processor causes said processor to:
determine from said talent buyer itinerary database a set of available performance records having a respective performance type and open location matching said gig type and said gig request location, respectively; and
communicate said set of available performance records to said requesting entertainer to review.

13. The online booking system as in claim 12, further comprising programming in said memory that when executed by said processor causes said processor to:
receive a booking request from said requesting entertainer indicative of an offer to book a respective open location selected from said set of available performance records;
communicate said booking request to a respective talent buyer associated with said respective open location; and
determine if said booking request is accepted by said respective talent buyer and, if so, update said talent buyer itinerary database to reflect acceptance of said booking offer.

14. The online booking system as in claim 3, further comprising programming in said memory that when executed by said processor causes said processor to:
determine from said act database and said act itinerary database a set of available acts that are available within a predetermined number of days of said performance request date and within a predetermined distance of said performance request location; and
communicate said set of available acts set to said talent buyer to review.

15. The online booking system as in claim 14, further comprising programming in said memory that when executed by said processor causes said processor to:
receive a booking request from said talent buyer indicative of an offer to book a respective act selected from said set of available acts;
communicate said booking request to a respective entertainer associated with said selected act; and
determine if said booking request is accepted by said respective entertainer and, if so, update said act itinerary database to reflect acceptance of said booking request.

16. The online booking system as in claim 15, further comprising programming in said memory that when executed by said processor causes said processor to:
notify said talent buyer after said booking request is accepted to make a payment according to predetermined parameters; and
notify said respective entertainer of non-payment if payment from said talent buyer is not received within a predetermined time prior to said performance request date.

17. The online booking system as in claim 5, further comprising:
a talent buyer itinerary database stored in said memory that includes performance itinerary records associated with a plurality of talent buyers, said performance itinerary record including an open date, an open location, and an open type, such that said itinerary database is indicative of open performances of respective talent buyers desiring to locate and book respective acts;
programming in said memory that when executed by said processor causes said processor to:
receive a gig request from a requesting entertainer over said computer network, said gig request including gig request data;
determine if said gig request data matches a respective performance itinerary record in said talent buyer itinerary database by comparing said gig request data with said performance itinerary records in said talent buyer itinerary database;
notify a respective talent buyer associated with said matched performance itinerary record to contact said requesting entertainer if said gig request data is determined to match said performance record associated with said respective talent buyer.

18. The online booking system as in claim 17, wherein said gig request data includes a gig date, a gig location, and a gig type, said online booking system further comprising programming in said memory that when executed by said processor causes said processor to:
determine from said talent buyer itinerary database a set of available performance records having a respective performance type and open date matching said gig type and said gig request date, respectively;
communicate said set of available performance records set to said requesting entertainer to review and edit;
receive a booking request from said requesting entertainer indicative of an offer to book a respective open date selected from said set of available performance records;
communicate said booking request to a respective talent buyer associated with said respective open date; and
determine if said booking request is accepted by said respective talent buyer and, if so, update said talent buyer itinerary database to reflect acceptance of said booking request.

19. The online booking system as in claim 18, further comprising programming in said memory that when executed by said processor causes said processor to:
determine from said talent buyer itinerary database a set of available performance records having a respective performance type and open location matching said gig type and said gig request location, respectively; and
communicate said set of available performance records to said requesting entertainer to review.

20. The online booking system as in claim 19, further comprising programming in said memory that when executed by said processor causes said processor to:
receive a booking request from said requesting entertainer indicative of an offer to book a respective open location selected from said set of available performance records;
communicate said booking request to a respective talent buyer associated with said respective open location; and
determine if said booking request is accepted by said respective talent buyer and, if so, update said talent buyer itinerary database to reflect acceptance of said booking request.
